(19) United States
(12) Patent Application Publication
(10) Pub. No.: US 2025/0109631 A1
(43) Pub. Date: Apr. 3, 2025

(54) SHADE MEMBER AND WINDOW BLIND HAVING SAME

(71) Applicant: Nien Made Enterprise Co., Ltd., Taichung City (TW)

(72) Inventor: Tzu-Hao Chiu, Taichung City (TW)

(73) Assignee: Nien Made Enterprise Co., Ltd., Taichung City (TW)

(21) Appl. No.: 18/896,840

(22) Filed: Sep. 25, 2024

(30) Foreign Application Priority Data
Sep. 28, 2023 (TW) 112210677

(51) Int. Cl. E06B 9/262; B29C 65/00

(52) U.S. Cl. CPC E06B 9/262; B29C 66/437; E06B 2009/2625

(57) ABSTRACT

A shade member and a window blind including multiple such shade members are provided. The shade member is made by welding a first shade element, a second shade element, and a third shade element together. The second shade element is situated on a first region of the first shade element, while the first shade element and the second shade element are unified by longitudinally overlapping and ultrasonic welding. The third shade element is situated on a second region of the first shade element, while the first shade element and the third shade element are unified by longitudinally overlapping and ultrasonic welding. Such a structure allows the shade member to easily include distinct portions made of different materials, so that the window blind including such shade members can provide a variety of appearance designs and texture combinations while lowering the production cost and increasing the production efficiency.

### BACKGROUND OF THE DISCLOSURE

### 1. Field of the Disclosure

The present disclosure relates generally to a window blind, and more particularly to a shade member and a window blind including multiple such shade members.

### 2. Description of the Prior Art

Currently, a vertical blind generally includes an upper rail and a covering part. The covering part is operably disposed on the upper rail and consists of multiple covering units. The user can control the covering part to extend, retract, or rotate, by operating a pull cord and/or a manipulation rod, to adjust intensity of outdoor incident light or avoid direct outdoor visibility into the indoor space to ensure personal privacy.

In early days, the cover units included in the covering part are usually made of one single fabric material entirely for each. However, this design causes some problems. Firstly, the cover units made of the single fabric materials appear monotonous and lack aesthetic appeal, failing to meet consumers' diverse requirements for the appearance of the vertical blinds. Secondly, due to the limit of the single fabric material, the light transmission level of the cover unit cannot vary in different areas thereon to match the users' diverse requirements.

Recently, several new designs emerge, proposing a type of cover unit made of one single fabric material but having multiple portions woven in different manners and formed integrally. Despite such the type of cover unit presents slightly altered patterns on different areas thereon, these designs require complicated manufacturing process during production, which leads to an increase of the production cost. Moreover, the texture variations generated by applying different weaving techniques to the cover unit only provides limited variability in appearance, thus there is room for improvement.

### SUMMARY OF THE DISCLOSURE

In light of the above reasons, one aspect of the present disclosure is to provide a shade member and a window blind including multiple such shade members allowing for various appearance designs and texture combinations while reducing production cost and enhancing production efficiency.

The shade member provided by the present disclosure comprises a first shade element, a second shade element, and a third shade element. The second shade element is situated on a first region of the first shade element, while the first shade element and the second shade element are unified by longitudinally overlapping with each other and ultrasonic welding. The third shade element is situated on a second region of the first shade element, while the first shade element and the third shade element are unified by longitudinally overlapping with each other and ultrasonic welding.

In one embodiment, a welding region between the first shade element and the second shade element and a welding region between the first shade element and the third shade element each have plural welding points distributed in plural non-continuous patterns that are arranged repeatedly.

In one embodiment, the first shade element and the second shade element are made of different materials, and the first shade element and the third shade element are made of different materials.

In one embodiment, either the first shade element comprises a thermoforming material, or both the second shade element and the third shade element comprise the thermoforming material.

In one embodiment, the thermoforming material comprises at least one of polyethylene terephthalate (PET), Nylon, polyethylene (PE), polypropylene (PP), polycarbonate (PC), polystyrene (PS), polyvinyl chloride (PVC), polylactide (PLA), ethylene vinyl acetate (EVA), polyurethane (PU), and polyamide (PA).

In one embodiment, either the first shade element comprises a first base and a first coating layer which comprises a thermoforming material, or the second shade element comprises a second base and a second coating layer which comprises the thermoforming material, and the third shade element comprises a third base and a third coating layer which comprises the thermoforming material.

In one embodiment, the second shade element is divided by a second midline extending longitudinally into a second inside region and a second outside region, in which the second inside region is close to the first shade element, and the second outside region is distanced from the first shade element. A welding region between the first shade element and the second shade element is within the second inside region of the second shade element. Meanwhile, the third shade element is divided by a third midline extending longitudinally into a third inside region and a third outside region, in which the third inside region is close to the first shade element, and the third outside region is distanced from the first shade element. A welding region between the first shade element and the third shade element is within the third inside region of the third shade element.

In one embodiment, the shade member further comprises a fourth shade element and a fifth shade element. The fourth shade element is situated on the first region of the first shade element, whereby the first region of the first shade element is sandwiched between the second shade element and the fourth shade element. Meanwhile, the fourth shade element and the first shade element are unified by longitudinally overlapping with each other and ultrasonic welding. Similarly, the fifth shade element is situated on the second region of the first shade element, whereby the second region of the first shade element is sandwiched between the third shade element and the fifth shade element. Meanwhile, the fifth shade element and the first shade element are unified by longitudinally overlapping with each other and ultrasonic welding.

Preferably, the fourth shade element and the second shade element are made of different materials, and the fifth shade element and the third shade element are made of different materials.

Preferably, a portion of the second shade element and a portion of the fourth shade element which do not overlap with the first shade element are attached to each other and unified by ultrasonic welding. Similarly, a portion of the third shade element and a portion of the fifth shade element which do not overlap with the first shade element are attached to each other and unified by ultrasonic welding.

The window blind provided by the present disclosure comprises a headrail, a control mechanism, and a covering material. The control mechanism is operably disposed in the headrail. The covering material includes multiple above-mentioned shade members, and is connected to the control mechanism, such that the covering material is drivable by the control mechanism to extend, retract, or rotate the above-mentioned shade members.

Through the above-mentioned features, the shade member and the window blind of the present disclosure provide various appearance designs and texture combinations, as well as lowering the production cost and increasing the production efficiency.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be understood by referring to the following detailed description of some illustrative embodiments in conjunction with the accompanying drawings, in which:

FIG. 1 is a perspective view of a window blind according to one embodiment of the present disclosure, in which the covering material of the window blind is in an open-and-translucent state;

FIG. 2 is an exploded perspective view of the window blind in FIG. 1;

FIG. 3 is a front view of the window blind in FIG. 1;

FIG. 4 is a perspective view of the shade member in FIG. 1;

FIG. 5 is a top view of the shade member in FIG. 4;

FIGS. 6-8 are schematic views of one embodiment of the shade member in FIG. 4, in which the shade member is flattened, and FIG. 6 is a rear view, FIG. 7 is a top view, and FIG. 8 is a front view;

FIG. 9 schematically shows another exemplified distribution of the welding points within the welding region of the shade member;

FIG. 10 schematically shows still another exemplified distribution of the welding points within the welding region of the shade member;

FIGS. 11-13 are schematic views of another embodiment of the shade member in FIG. 4, in which the shade member is flattened, and FIG. 11 is a rear view, FIG. 12 is a top view, and FIG. 13 is a front view;

FIGS. 14-16 are schematic views of still another embodiment of the shade member in FIG. 4, in which the shade member is flattened, and FIG. 14 is a rear view, FIG. 15 is a top view, and FIG. 16 is a front view.

### DETAILED DESCRIPTION

In the following paragraphs and the accompanying drawings, the features and the implementations of several embodiments of the present disclosure are described in more detail along with the accompanying drawings. The features and the implementations described in the following paragraphs can be adopted solely or in combination with each other. In addition, the embodiments can be modified in various forms, as disclosed in the following paragraphs, and should not be limited to the embodiments described in the following paragraphs. Unless specified otherwise, the same reference characters refer to the same components.

The technical features provided in the present disclosure are not limited to the specific structures, uses, and applications described in the embodiments. The language used in the descriptions is illustrative and descriptive language which can be understood by the person of ordinary skill in the art. The terms regarding directions mentioned in the specification, including “front”, “rear”, “up”, “down”, “left”, “right”, “top”, “bottom”, “inside”, and “outside”, are illustrative and descriptive terms based on common usage scenarios, and manifests no intent to limit the scope of claims.

Furthermore, the definite and indefinite articles “a” and “the” and the numerical term “one” used in the specification referring to components of singular form do not exclude the concept of plural form. Equivalences known by one having ordinary skill in the art should be also included. All conjunctions used in similar situations should be interpreted in the broadest ways. The specific shapes, structural features, and technical terms described in the descriptions should also be interpreted to include equivalent structures and techniques which could achieve the same functionality.

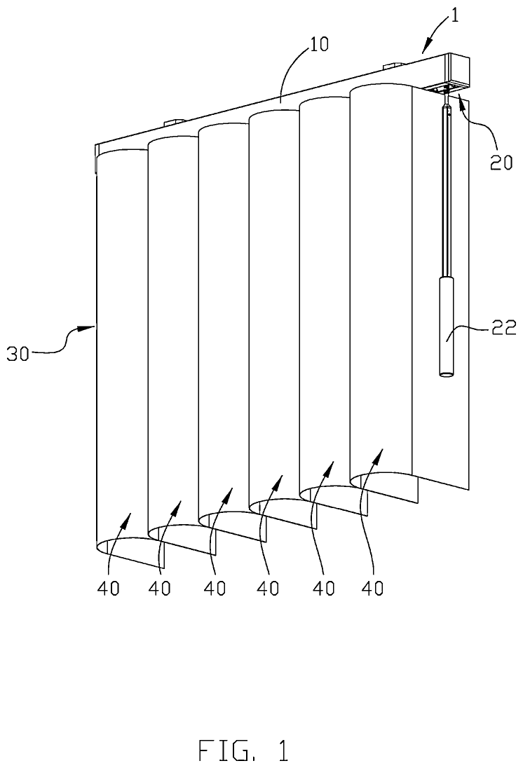

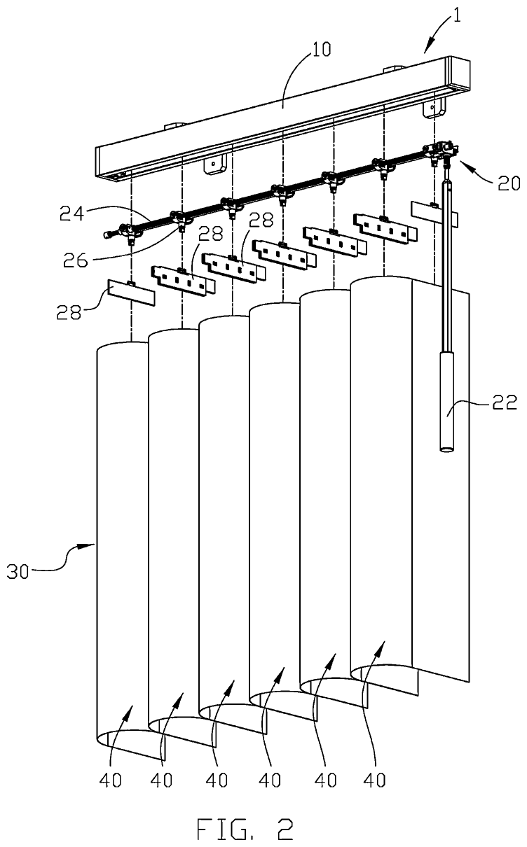

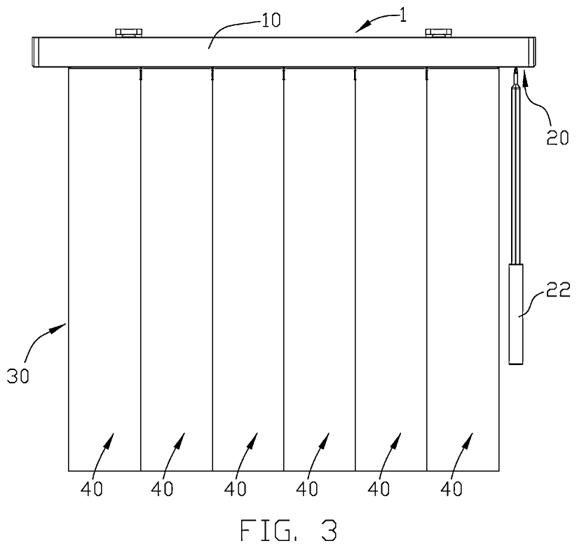

Please refer to FIG. 1, FIG. 2, and FIG. 3, which show a window blind 1 according to one embodiment of the present disclosure. The window blind 1 can be disposed on an architecture opening, such as a window, a door, an arched door, or any other similar structure. The window blind 1 comprises a headrail 10, a control mechanism 20, and a covering material 30.

In the present embodiment, the headrail 10 is made of a rigid material, such as plastic, metal, a compound metal, or a composite material. The headrail 10 is generally a hollow cuboid, defining a containing space for receiving part of the control mechanism 20. The control mechanism 20 comprises an operating rod 22, a transmission shaft 24, plural sliding seats 26, and plural connectors 28. Referring to FIG. 1, the operating rod 22 is exposed to the exterior of the headrail 10. Referring to FIG. 2, the transmission shaft 24, the sliding seats 26, and the connectors 28 are disposed within the containing space of the headrail 10. The covering material 30 is suspended below the headrail 10 through the transmission shaft 24, the sliding seats 26, and the connectors 28 of the control mechanism 20 which are disposed within the containing space of the headrail 10. Subjected to different scenarios, the user can control the covering material 30 to extend, retract, or rotate through the control mechanism 20.

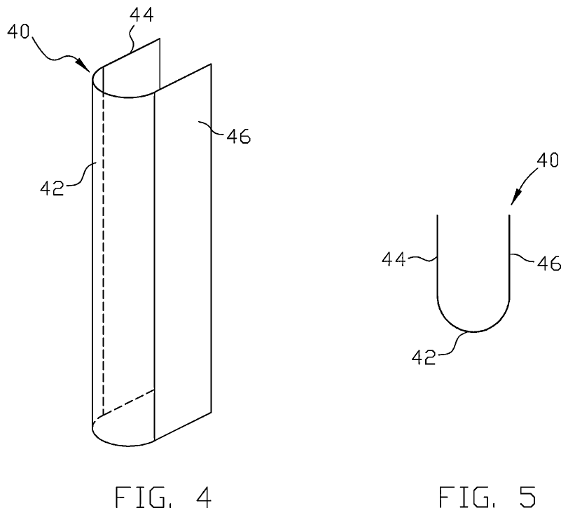

Please refer to FIGS. 1 to 5. The covering material 30 comprises plural shade members 40. The number of the shade members 40 can be increased or decreased in accordance with the breadth of the window blind 1 or different design requirements. When the covering material 30 of the window blind 1 is in an open-and-translucent state as shown in FIG. 1, the shade members 40 each exhibit a U-shaped configuration, with one disposed in close contact with another. More specifically, each of the shade members 40 has an arc-shaped translucent part and two opaque sheets coupled with two lateral of sides the arc-shaped translucent part respectively. The arc-shaped translucent parts of the shade members 40 are arranged in a line and filling the front side of the covering material 30, while the opaque sheets of the shade members 40 are perpendicular to the front side of the covering material 30. The shade members 40 are independent from each other, such that the shade members 40 can be separated from each other when subjected to force. That is, the user is allowed to freely pass through the covering material 30 among the shade members 40.

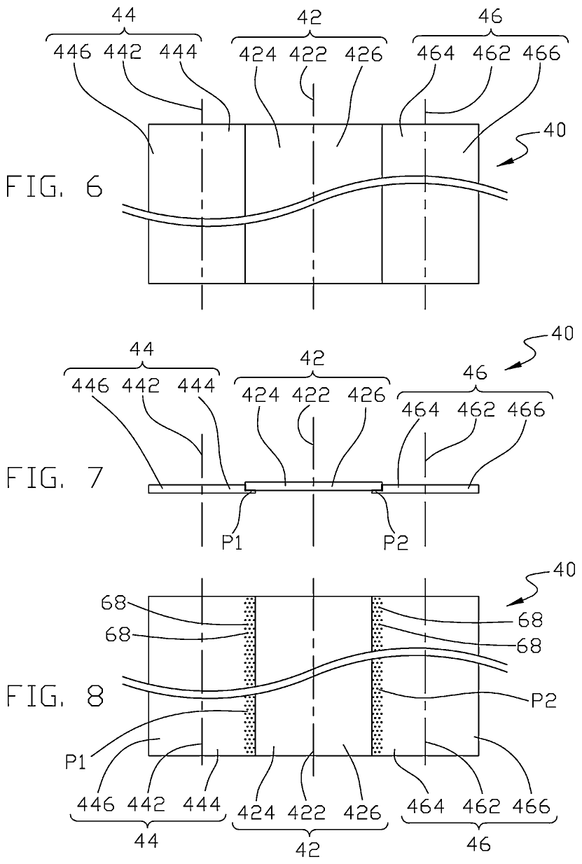

Please refer to FIG. 6, FIG. 7, and FIG. 8, which are schematic views of one embodiment of the shade member, in which the shade member is flattened. FIG. 6 is a rear view, FIG. 7 is a top view, and FIG. 8 is a front view. In the present embodiment, the shade member 40 includes a first shade element 42, a second shade element 44, and a third shade element 46. The first shade element 42 is divided into a first region 424 and a second region 426 by a first midline 422 extending longitudinally. The second shade element 44 is disposed on the first region 424, while the first shade element 42 and the second shade element 44 are unified by longitudinally overlapping with each other and ultrasonic welding. The third shade element 46 is disposed on the second region 426, while the first shade element 42 and the third shade element 46 are unified by longitudinally overlapping with each other and ultrasonic welding.

In the present embodiment, the first shade element 42 and the second shade element 44 are made of different materials. The first shade element 42 and the third shade element 46 are also made of different materials, but the materials of the second shade element 44 and the third shade element 46 are the same. In some other embodiments, the materials of the first shade element, the second shade element, and the third shade element are all the same. In some other embodiments, the materials of the first shade element, the second shade element, and the third shade element are all different. In some other embodiments, the materials of the first shade element and the second shade element are the same, but the first shade element and the third shade element are made of different materials.

However, in spite of choosing whether material to produce the first shade element 42, the second shade element 44, and the third shade element 46, either the first shade element 42 must include a thermoforming material or both the second shade element 44 and the third shade element 46 must include the thermoforming material. Therefore, the second shade element 44 and the third shade element 46 can be welded onto the first shade element 42 by ultrasonic welding. More specifically, in some embodiments, the first shade element 42 includes the thermoforming material, while the second shade element 44 and the third shade element 46 do not necessarily include the thermoforming material. In some other embodiments, the second shade element 44 and the third shade element 46 both include the thermoforming material, while the first shade element 42 does not necessarily include the thermoforming material. In some further other embodiments, the first shade element 42, the second shade element 44, and the third shade element 46 all include the thermoforming material. Through the characteristic of the thermoforming material that can melt and then re-solidify during the ultrasonic welding process, different shade elements (i.e., the first shade element 42, the second shade element 44, and the third shade element 46) can be unified by welding to form the shade member 40.

The aforesaid thermoforming material may include at least one of polyethylene terephthalate (PET), Nylon, polyethylene (PE), polypropylene (PP), polycarbonate (PC), polystyrene (PS), polyvinyl chloride (PVC), polylactide (PLA), ethylene vinyl acetate (EVA), polyurethane (PU), and polyamide (PA). The thermoforming material may be presented in a fibrous manner, being served as one of multiple materials or as the sole material for the shade element. Alternatively, the thermoforming material can be applied in the form of a surface coating.

In the embodiment shown in FIG. 6, FIG. 7, and FIG. 8, both the second shade element 44 and the third shade element 46 are entirely made of the thermoforming material, e.g., the non-woven fabrics composed of polyester or a blend of polyester and nylon fibers, whereas the first shade element 42 does not include the thermoforming material and is made of a natural fiber, e.g., cotton or linen. As shown in FIG. 6, FIG. 7, and FIG. 8, after the ultrasonic welding process, the second shade element 44 and the third shade element 46 have been partially melted and then re-solidified onto the first shade element 42, forming two welding regions P1, P2. In the present embodiment, on the basis that the second shade element 44 and the third shade element 46 are made of the thermoforming material while the first shade element 42 does not include the thermoforming material, after ultrasonic welding, the welding regions P1, P2 of the shade member 40 are visible from the front view (referring to the plural welding points 68 shown in FIG. 8) but invisible from the rear view (see FIG. 6). By contrast, if the front-and-rear positions of the second shade element 44 and the third shade element 46 with respect to the first shade element 42 were exchanged, after ultrasonic welding, the welding regions will be visible from the rear view, and be invisible from the front view. It is understandable that if all the shade elements (i.e., the first shade element, the second shade element, and the third shade element) were made of the thermoforming material, after ultrasonic welding, the welding regions will be visible and recognizable from both the front and rear views.

In some other embodiments, the second shade element and the third shade element are made of a composite material composed of a thermoforming material and other materials, as taking into account factors like user aesthetic preferences, interior design considerations, and translucent levels. The aforesaid other materials may include yarn, cloth, natural fibers, synthetic fibers, plastics, wood, or metal, and may be shaped into fabrics by formation processes, such as weaving, knitting, braiding, or non-woven fabric formation.

Please refer to FIG. 6, FIG. 7, and FIG. 8 again. In the present embodiment, the second shade element 44 is divided into a second inside region 444 and a second outside region 446 by a second midline 442 extending longitudinally. The second inside region 444 is close to the first shade member 42, while the second outside region 446 is distanced from the first shade member 42. The welding region P1 between the first shade member 42 and the second shade element 44 formed by ultrasonic welding is within the second inside region 444 of the second shade element 44. Meanwhile, the third shade element 46 is divided into a third inside region 464 and a third outside region 466 by a third midline 462 extending longitudinally. The third inside region 464 is close to the first shade member 42, while the third outside region 466 is distanced from the first shade member 42. The welding region P2 between the first shade member 42 and the third shade element 46 formed by ultrasonic welding is within the third inside region 464 of the third shade element 46.

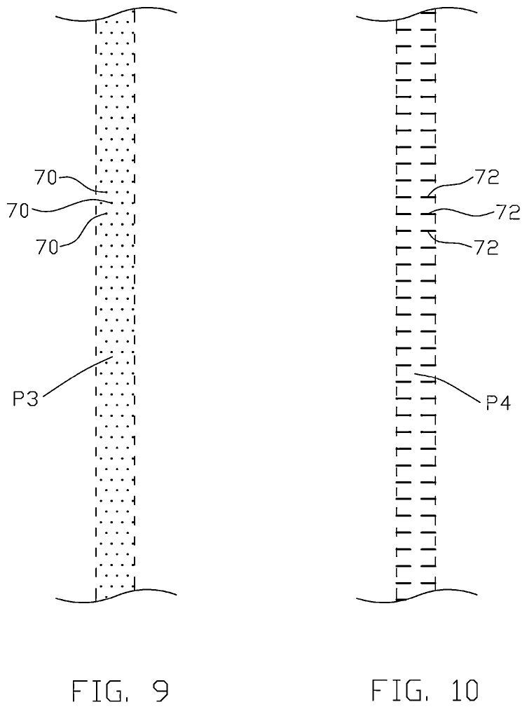

Please refer to FIG. 8, FIG. 9, and FIG. 10. In the present embodiment, the welding region P1 between the first shade member 42 and the second shade element 44, and the welding region P2 between the first shade member 42 and the third shade element 46, each have plural welding points 68 distributed in plural non-continuous patterns. Such non-continuous patterns are arranged in a repeated manner. Thus, the risk of the shade elements (i.e., the first shade element 42, the second shade element 44, and the third shade element 46) tearing apart from the edge of the welding regions P1, P2 when pulled by users is reduced. Referring to FIG. 9, which shows another exemplified distribution of the welding points. As shown in FIG. 9, the welding points 70 within a welding region P3 are each presented as a dot. Referring to FIG. 10, which shows still another exemplified distribution of the welding points. As shown in FIG. 10, the welding points 72 within a welding region P4 are each presented as a short traverse line. By distributing the welding points 68, 70, and 72 within the welding regions P1, P2, P3, and P4 in a non-continuous manner, the shade member 40 can be better resistant for tear. Apart from that, considering the stability and reliability of the ultrasonic welding method, the ultrasonic welding equipment is suggested to contact either the shade elements that include the thermoforming material or the surface coatings of the thermoforming material applied to the shade elements. This ensures the thermoforming material certainly melts at each of the welding points 68, 70, and 72.

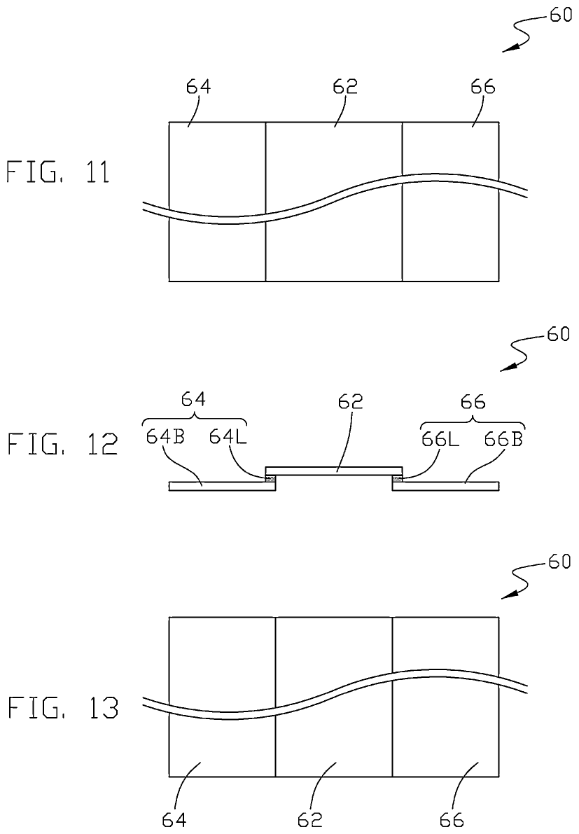

Please refer to FIG. 11, FIG. 12, and FIG. 13, which are schematic views of another embodiment of the shade member, in which the shade member is flattened. FIG. 11 is a rear view, FIG. 12 is a top view, and FIG. 13 is a front view. In the present embodiment, a first shade element 62, a second shade element 64, and a third shade element 66 are unified by ultrasonic welding to form a shading member 60. The second shade element 64 comprises a second base 64B and a second coating layer 64L. The third shade element 66 comprises a third base 66B and a third coating layer 66L. The second coating layer 64L and the third coating layer 66L both comprise the thermoforming material, while the thermoforming material may include at least one of polyethylene terephthalate (PET), Nylon, polyethylene (PE), polypropylene (PP), polycarbonate (PC), polystyrene (PS), polyvinyl chloride (PVC), polylactide (PLA), ethylene vinyl acetate (EVA), polyurethane (PU), and polyamide (PA). The thermoforming material has no viscosity and is in a solidified state under the indoor temperature. Only when exposed to the high temperature in the ultrasonic welding process, the thermoforming material melts and starts being sticky. According to different process requirements, the coating layers for use in the ultrasonic welding process may be coated on the entire bases or merely coated on part of the bases. As shown in FIG. 11, FIG. 12, and FIG. 13, the second coating layer 64L is only distributed on an area on the second base 64B adjacent to the first shade element 62, while the third coating layer 66L is only distributed on an area on the third base 66B adjacent to the first shade element 62. In the process of welding the first shade element 62, the second shade element 64, and the third shade element 66 by using ultrasonic welding, the second coating layer 64L of the second shade element 64 and the third coating layer 66L of the third shade element 66 partially melt initially and then re-solidify onto the first shade element 62, forming the welding regions.

The shade member 60 shown in FIG. 11, FIG. 12, and FIG. 13 has advantages as described below. Since the thermoforming material for use in welding the shade elements (i.e., the second shade element 64 and the second shade element 66) is distributed on the surfaces of the bases (i.e., the second base 64B and the third base 66B), the bases can be chosen from a variety of materials as long as allowing the thermoforming material to attach thereto. In addition, since the coating layers (i.e., the second coating layer 64L and the third coating layer 66L) that include the thermoforming material have no viscosity under the indoor temperature, the first shade element 62, the second shade element 64, and the third shade element 66 can be stored and received separately before progressing ultrasonic welding upon the shade member 60, which is beneficial to storage management and material transportation. Moreover, as the first shade element 62, the second base 64B, and the third base 66B are made of opaque materials in the present embodiment, the welding regions formed after ultrasonic welding are invisible from both the front view (see FIG. 13) and the rear view (see FIG. 11), resulting in consistent appearance of the shade member 60 from the front and the rear sides. Therefore, there is less limitation on manufacture and applied range of the shade member 60.

In the above-mentioned embodiments shown in FIGS. 6 to 13, both the second shade element and the third shade element necessarily include the thermoforming material. However, in some other embodiments, the first shade element is the one necessarily including the thermoforming material. In that case, the first shade element may be solely made of the thermoforming material or made of a composite material, while the composite material is composed of a blend of the thermoforming material and the other materials. Alternatively, the material of the first shade element may be a piece of fabric with a surface coating of the thermoforming material applied thereon, while the fabric itself may be made of the thermoforming material and/or the other materials.

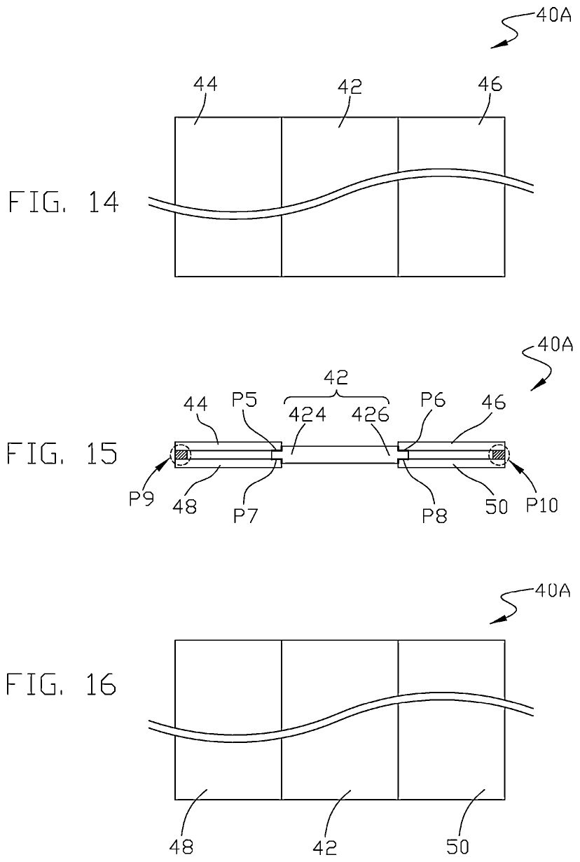

Please refer to FIG. 14, FIG. 15, and FIG. 16, which are schematic views of still another embodiment of the shade member, in which the shade member is flattened. FIG. 14 is a rear view, FIG. 15 is a top view, and FIG. 16 is a front view. In the present embodiment, the shade member 40A comprises a first shade element 42, a second shade element 44, a third shade element 46, a fourth shade element 48, and a fifth shade element 50.

In the present embodiment, both the fourth shade element 48 and the second shade element 44 are disposed on a first region 424 of the first shade element 42, making the first region 424 sandwiched between the second shade element 44 and the fourth shade element 48. Meanwhile, the second shade element 44 and the fourth shade element 48 are unified with the first shade element 42 by ultrasonic welding in a longitudinal stacking manner.

Similarly, both the third shade element 46 and the fifth shade element 50 are disposed on a second region 426 of the first shade element 42, making the second region 426 sandwiched between the third shade element 46 and the fifth shade element 50. Meanwhile, the third shade element 46 and the fifth shade element 50 are unified with the first shade element 42 by ultrasonic welding in the longitudinal stacking manner.

In the present embodiment, the widths, lengths, and materials of the second shade element 44 and the fourth shade element 48 are the same. Meanwhile, the widths, lengths, and materials of the third shade element 46 and the fifth shade element 50 are the same. In some other embodiments, the widths, lengths, and materials of the shade elements can be varied depending on users' requirements to achieve specific aesthetic appeal or a specific light-shielding effect.

Nevertheless, in spite of the widths, lengths, and materials of the shade elements (i.e., the first shade element 42, the second shade element 44, the third shade element 46, the fourth shade element 48, and the fifth shade element 50), for the purpose of welding the second shade element 44, the third shade element 46, the fourth shade element 48, and the fifth shade element 50 onto the first shade element 42 by ultrasonic welding, the first shade element 42 must comprise the thermoforming material. At the same time, the second shade element 44, the third shade element 46, the fourth shade element 48, and the fifth shade element 50 do not necessarily comprise the thermoforming material. Alternatively, in some other embodiments, all the second shade element, the third shade element, the fourth shade element, and the fifth shade element all comprise the thermoforming material as a must, whereas the first shade element does not necessarily comprise the thermoforming material.

In the embodiment shown in FIG. 14, FIG. 15, and FIG. 16, the first shade element 42 is entirely made of the thermoforming material, e.g., non-woven fabrics composed of polyester. Meanwhile, the second shade element 44, the third shade element 46, the fourth shade element 48, and the fifth shade element 50 do not include the thermoforming material and are made of natural fibers, e.g., cotton or linen. In the ultrasonic welding process, the first shade element 42 partially melts initially, and then re-solidify and is attached to the second shade element 44, the third shade element 46, the fourth shade element 48, and the fifth shade element 50, respectively, forming plural welding regions P5, P6, P7, and P8.

In the present embodiment, only the first shade element 42 includes the thermoforming material rather than the second shade element 44, the third shade element 46, the fourth shade element 48, and the fifth shade element 50. As a result, the first shade element 42 is the only one melted in the process of ultrasonic welding among the shade members for forming the welding regions P5, P6, P7, and P8. Meanwhile, the second shade element 44, the third shade element 46, the fourth shade element 48, and the fifth shade element 50 can shelter the fused and deformed sections of the first shade element 42. Therefore, the window blind 40A has more aesthetic appeal of its overall appearance.

Preferably, the portions of the second shade element 44 and the fourth shade element 48 not overlapped with the first shade element 42 are provided with a surface coating of the thermoforming material on at least one of them, so that they can be joined by ultrasonic welding and consequently form a connecting region P9, as shown in FIG. 15. In some other embodiments, the portions of the second shade element 44 and the fourth shade element 48 not overlapped with the first shade element 42 are joined by using adhesive or stitching methods. In a similar manner, the portions of the third shade element 46 and the fifth shade element 50 not overlapped with the first shade element 42 are provided with a surface coating of the thermoforming material on at least one of them, so that they can be joined by ultrasonic welding and consequently form a connecting region P10, as shown in FIG. 15. In some other embodiments, the portions of the third shade element 46 and the fifth shade element 50 not overlapped with the first shade element 42 are joined by using adhesive or stitching methods. The double-layer structure of the joined shade elements (i.e., the second shade element 44 and the fourth shade element 48; or the third shade element 46 and the fifth shade element 50) improves not only the light-shielding effect of the shade member 40A, but also the buckling resistance of the shade member 40A.

It is worthy to note that the covering material of the window blind of the present disclosure for use in one window is not limited to include only one single type of the shade member 40, 40A or 60. In some embodiments, the covering material of the window blind includes at least two types of the shade members selected from the shade members 40, 60 and 40A. For example, the covering material may consist of the shade members 40 and the shade members 40A arranged alternatively, presenting a design texture of repeated staggered placement. In some other embodiments, the covering material of the window blind includes several shade members 40A disposed at the two lateral sides of the covering material, and includes multiple shade members 40 disposed between the shade members 40A. Since the shade elements 40A have the double-layer structures with an improved light-shielding effect compared to the shade elements 40, this disposition enhances the light blocking levels of the two lateral sides of the covering material, thereby preventing light leakage from the two lateral sides of the covering material.

In sum, the shade members 40, 40A and 60 of the present disclosure are made by using ultrasonic welding to combine multiple shade elements together while the shade elements can be made of different materials, thereby achieving specified visual style and usage requirement as well as decreasing the production cost and raising the production efficiency.

The embodiments described above are only some exemplary embodiments of the present disclosure. All equivalent structures which employ the concepts disclosed in this specification and the appended claims should fall within the scope of the present disclosure.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A shade member, comprising:
a first shade element;
a second shade element; and
a third shade element;
wherein the second shade element is situated on a first region of the first shade element, while the first shade element and the second shade element are unified by longitudinally overlapping with each other and ultrasonic welding; the third shade element is situated on a second region of the first shade element, while the first shade element and the third shade element are unified by longitudinally overlapping with each other and ultrasonic welding.

2. The shade member of claim 1, wherein the first shade element and the second shade element are made of different materials, and the first shade element and the third shade element are made of different materials.

3. The shade member of claim 1, wherein either the first shade element comprises a thermoforming material, or both the second shade element and the third shade element comprise the thermoforming material.

4. The shade member of claim 3, wherein the thermoforming material comprises at least one of polyethylene terephthalate (PET), Nylon, polyethylene (PE), polypropylene (PP), polycarbonate (PC), polystyrene (PS), polyvinyl chloride (PVC), polylactide (PLA), ethylene vinyl acetate (EVA), polyurethane (PU), and polyamide (PA).

5. The shade member of claim 1, wherein either the first shade element comprises a first base and a first coating layer which comprises a thermoforming material, or the second shade element comprises a second base and a second coating layer which comprises the thermoforming material, and the third shade element comprises a third base and a third coating layer which comprises the thermoforming material.

6. The shade member of claim 5, wherein the thermoforming material comprises at least one of polyethylene terephthalate (PET), Nylon, polyethylene (PE), polypropylene (PP), polycarbonate (PC), polystyrene (PS), polyvinyl chloride (PVC), polylactide (PLA), ethylene vinyl acetate (EVA), polyurethane (PU), and polyamide (PA).

7. The shade member of claim 1, wherein the second shade element is divided into a second inside region and a second outside region by a second midline extending longitudinally; the second inside region is close to the first shade element, and the second outside region is distanced from the first shade element; a welding region between the first shade element and the second shade element is within the second inside region of the second shade element; the third shade element is divided into a third inside region and a third outside region by a third midline extending longitudinally; the third inside region is close to the first shade element, and the third outside region is distanced from the first shade element; a welding region between the first shade element and the third shade element is within the third inside region of the third shade element.

8. The shade member of claim 7, wherein the welding region between the first shade element and the second shade element is visible from at least one of the first shade element and the second shade element; the welding region between the first shade element and the third shade element is visible from at least one of the first shade element and the third shade element.

9. The shade member of claim 7, wherein the welding region between the first shade element and the second shade element is invisible as being hidden between the first shade element and the second shade element; the welding region between the first shade element and the third shade element is invisible as being hidden between the first shade element and the third shade element.

10. The shade member of claim 1, further comprising a fourth shade element and a fifth shade element, wherein the fourth shade element is situated on the first region of the first shade element, whereby the first region of the first shade element is sandwiched between the second shade element and the fourth shade element; the fourth shade element and the first shade element are unified by longitudinally overlapping with each other and ultrasonic welding; the fifth shade element is situated on the second region of the first shade element, whereby the second region of the first shade element is sandwiched between the third shade element and the fifth shade element; the fifth shade element and the first shade element are unified by longitudinally overlapping with each other and ultrasonic welding.

11. The shade member of claim 10, wherein the fourth shade element and the second shade element are made of different materials, and the fifth shade element and the third shade element are made of different materials.

12. A window blind, comprising:
a headrail;
a control mechanism, operably disposed in the headrail; and
a covering material, connected to the control mechanism to be drivable by the control mechanism to extend, retract, or rotate; the covering material comprising plural shade members, each of the plural shade members comprising:
a first shade element;
a second shade element; and
a third shade element;
wherein the second shade element is situated on a first region of the first shade element, while the first shade element and the second shade element are unified by longitudinally overlapping with each other and ultrasonic welding; the third shade element is situated on a second region of the first shade element, while the first shade element and the third shade element are unified by longitudinally overlapping with each other and ultrasonic welding.

13. The window blind of claim 12, wherein a welding region between the first shade element and the second shade element and a welding region between the first shade element and the third shade element each have plural welding points distributed in plural non-continuous patterns that are arranged repeatedly.

14. The window blind of claim 12, wherein either the first shade element comprises a thermoforming material, or both the second shade element and the third shade element comprise the thermoforming material.

15. The window blind of claim 12, wherein either the first shade element comprises a first base and a first coating layer which comprises a thermoforming material, or the second shade element comprises a second base and a second coating layer which comprises the thermoforming material, and the third shade element comprises a third base and a third coating layer which comprises the thermoforming material.

16. The window blind of claim 12, wherein the second shade element is divided into a second inside region and a second outside region by a second midline extending longitudinally; the second inside region is close to the first shade element, and the second outside region is distanced from the first shade element; a welding region between the first shade element and the second shade element is within the second inside region of the second shade element; the third shade element is divided into a third inside region and a third outside region by a third midline extending longitudinally; the third inside region is close to the first shade element, and the third outside region is distanced from the first shade element; a welding region between the first shade element and the third shade element is within the third inside region of the third shade element.

17. The window blind of claim 16, wherein the welding region between the first shade element and the second shade element is visible from at least one of the first shade element and the second shade element; the welding region between the first shade element and the third shade element is visible from at least one of the first shade element and the third shade element.

18. The window blind of claim 16, wherein the welding region between the first shade element and the second shade element is invisible as being hidden between the first shade element and the second shade element; the welding region between the first shade element and the third shade element is invisible as being hidden between the first shade element and the third shade element.

19. The window blind of claim 12, wherein each of the plural shade members further comprises a fourth shade element and a fifth shade element; the fourth shade element is situated on the first region of the first shade element, whereby the first region of the first shade element is sandwiched between the second shade element and the fourth shade element; the fourth shade element and the first shade element are unified by longitudinally overlapping with each other and ultrasonic welding; the fifth shade element is situated on the second region of the first shade element, whereby the second region of the first shade element is sandwiched between the third shade element and the fifth shade element; the fifth shade element and the first shade element are unified by longitudinally overlapping with each other and ultrasonic welding.

20. The window blind of claim 19, wherein a portion of the second shade element and a portion of the fourth shade element which do not overlap with the first shade element are attached to each other to become unified by one of ultrasonic welding, adhering and stitching; a portion of the third shade element and a portion of the fifth shade element which do not overlap with the first shade element are attached to each other to become unified by one of ultrasonic welding, adhering and stitching.
